(19) United States
(12) Patent Application Publication
(10) Pub. No.: US 2016/0368218 A1
(43) Pub. Date: Dec. 22, 2016

(54) 3D Printers, 3D Printing Systems and Methods of Use and Manufacture

(71) Applicants: Josue Cruz, Germantown, MD (US); Jamie Lee, Germantown, MD (US)

(72) Inventors: Josue Cruz, Germantown, MD (US); Jamie Lee, Germantown, MD (US)

(21) Appl. No.: 15/088,111

(22) Filed: Mar. 31, 2016

Related U.S. Application Data
(60) Provisional application No. 62/141,233, filed on Mar. 31, 2015.

(51) Int. Cl. B29C 67/00

(52) U.S. Cl. CPC B29C 67/0085; B33Y 30/00

(57) ABSTRACT

A 3D printing machine that can include an L shaped housing with a tower portion and a base portion. The X carriage creates a cantilever design. The base can include attachment points for a gear head extruder assembly location, a Z axis rod threaded rod attachment for the Z carriage and provide a location of wiring and Bowden insertion to tower portion. The print bed can be arranged off center that makes use of platform rigidity, double and single extrusion X carriage with a proximity sensor attached the of frontal site of the extruder assembly. The extruder universal back plate can include a sheet metal design that includes or otherwise covers the extruder head and fan cover, and proximity sensor, and allow modular attachments of a single or double extruder.

### BACKGROUND

The disclosed subject matter relates to 3D printers, 3D printing systems and methods of use and manufacture. More particularly, the disclosed subject matter relates to devices and apparatuses for 3D printers and CNC milling machines, including small CNC milling machines.

Three-dimensional printers, also called fused deposition modeling or fused filament fabrication printers, can use a printhead which applies layers of thermoplastic such as ABS, HDPE, PLA, PVA, etc. to a metal or metal containing carrier, or polymers and composites that are doped with a variety of secondary materials, such as metals, wood and carbon nano-tubes, to create models, prototypes, patterns, and production parts.

Fused filament fabrication is performed by laying down material in layers. Fused filament fabrication, i.e. three-dimensional printing, in addition to providing three-dimensional models or parts for conceptual design studies also allows the manufacturing of functional items or tooling. Patterns for various metal and plastic casting technologies can also be formed. Typically, a plastic filament or metal wire is unwound from a coil by a small motor that supplies material to an extrusion nozzle that can start and stop material flow. The nozzle is heated to melt the material and can be moved in both horizontal and vertical directions by a numerically controlled mechanism that can be directly controlled by a controller using software, such as computer-aided manufacturing (CAM) software packages. The model or part is produced by extruding small amounts of thermoplastic or other material to form layers as the material hardens after deposition onto the layer from the nozzle. Tools for thermoforming and injection molding can be made, as well as fixtures which assist the manufacturing operation. In addition to providing for manufacturing functional objects, art objects and display objects can be readily manufactured. Improvements of fused filament fabrication printers requires an increase in printing speed, printing with multiple materials, and lower printer costs.

### SUMMARY

A problem with some 3D printers and small milling CNC machines is that they tend to reduce the effective working area due to their large box-like and/or enclosed shapes. Other limitations can be that 3D print heads and other apparatuses do not allow for modularity and interchangeability. Some disadvantages also include larger build volumes due to having cross beam support of the Y-axis. This can cause slower printing operations due to an idler motor placed directly over a nozzle. This configuration also requires a smaller print bed to minimize vibration, such as horizontal vibrations. Other disadvantages include a Z-axis not being supported from top and bottom. This creates the possibility of more vibrations at high-speed printing. Some printing device electronics are open and exposed to the environment providing potential damage by water, moisture, or physical interferences. Some printers also do not include a monitor or screen with a graphical user interface integrated with the printer controls to monitor the printer and provider user control over the printer.

Other disadvantages to some 3D printers can include only providing a mono extruder due to the riding motor on a Z axis. Other 3D printers cannot increase print bed size due to a non-modular print bed or require multiple different components to change the print size.

Thus, it may be beneficial to address at least one of the issues identified above. In addition, it may be beneficial or necessary in the context of a 3D printing machine to provide a design of the embodiments that advantageously provides visibility and access to three sides of the print bed allowing easy removal of a printed object and maintenance of the print bed. It may also be beneficial to provide modularity of devices or apparatus for a 3D printer. Some of the disclosed embodiments therefore relate to systems and devices configured with technology for 3D printing including computer implemented methods, systems, computer aided designs, and other designs for 3D printing technology and CNC milling machines.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a 3D printer in accordance with the disclosed subject matter.

FIG. 2 is a front view of the embodiment for the 3D printer of FIG. 1.

FIG. 3 is a side view of the embodiment for the 3D printer of FIG. 1.

FIG. 4 is a plan view of the embodiment for the 3D printer of FIG. 1.

FIG. 5 is a front view of an embodiment for a double extruder X carriage assembly in accordance with the disclosed subject matter.

FIG. 6 is a perspective view of an embodiment for a double extruder X carriage assembly in accordance with the disclosed subject matter.

FIG. 7 is a front view of an embodiment for a single extruder X carriage assembly in accordance with the disclosed subject matter.

FIG. 8 is a perspective view of an embodiment for a single extruder X carriage assembly in accordance with the disclosed subject matter.

FIG. 9 is a perspective view of another embodiment for a 3D printer in accordance with the disclosed subject matter.

FIG. 10 is a plan view of the embodiment for a 3D printer of FIG. 9.

FIG. 11 is a partial front view of the embodiment for a 3D printer of FIG. 9.

FIG. 12 is a front perspective view of the embodiment for a 3D printer of FIG. 9.

FIG. 13 is a front perspective view of the embodiment for a 3D printer of FIG. 9 with manufactured articles.

FIG. 14 is a perspective view of 3D printer internal construction and components in accordance with the disclosed subject matter.

FIG. 15 is top perspective view of a Z axis housing and idler motors in accordance with the disclosed subject matter.

FIG. 16 is a detailed rear view of a printer base portion in accordance with the disclosed subject matter.

FIG. 17 is a front perspective view of an embodiment for a double extruder X carriage assembly in accordance with the disclosed subject matter.

FIG. 18 is an exploded view and assembled view of an embodiment for a universal back plate assembly in accordance with the disclosed subject matter.

FIG. 19 is a detailed perspective view of pulley systems in accordance with the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Like features on different embodiments are given similar reference numbers.

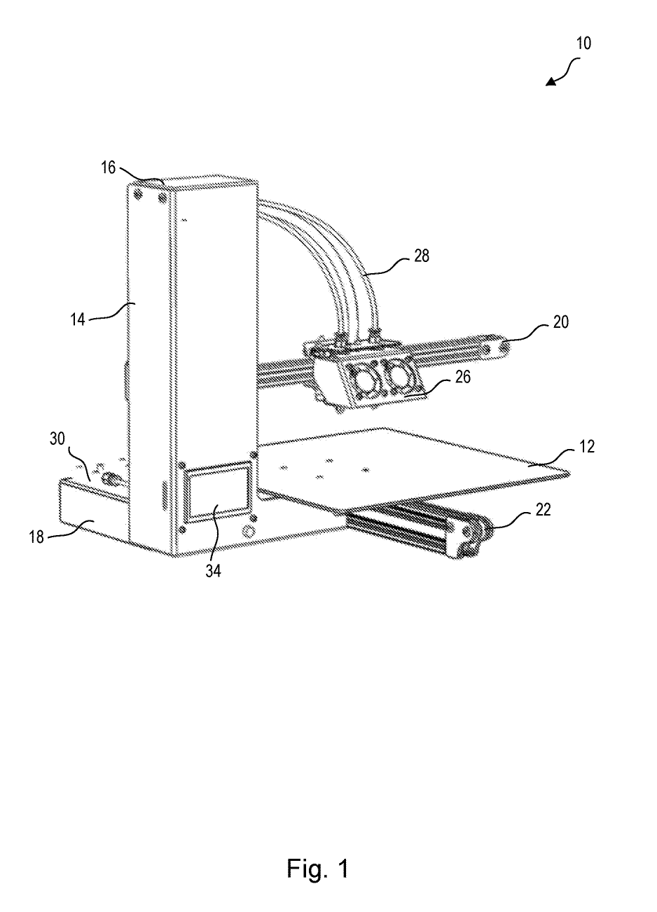

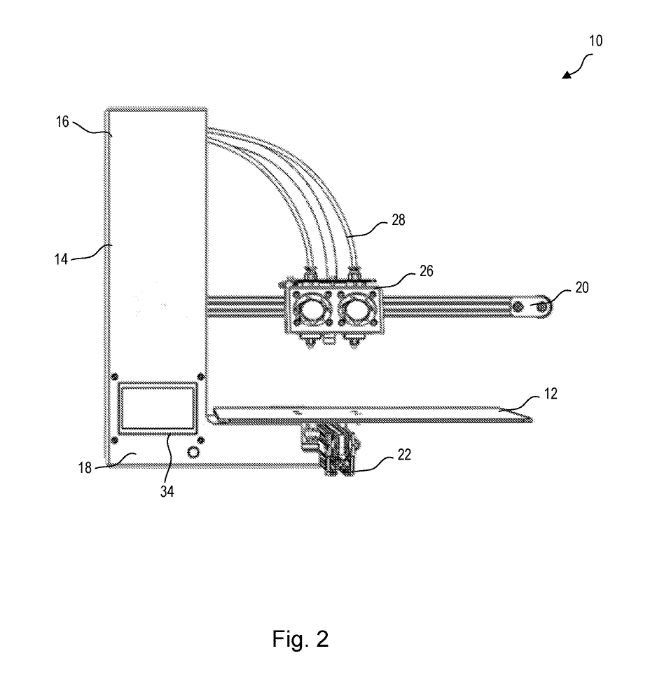

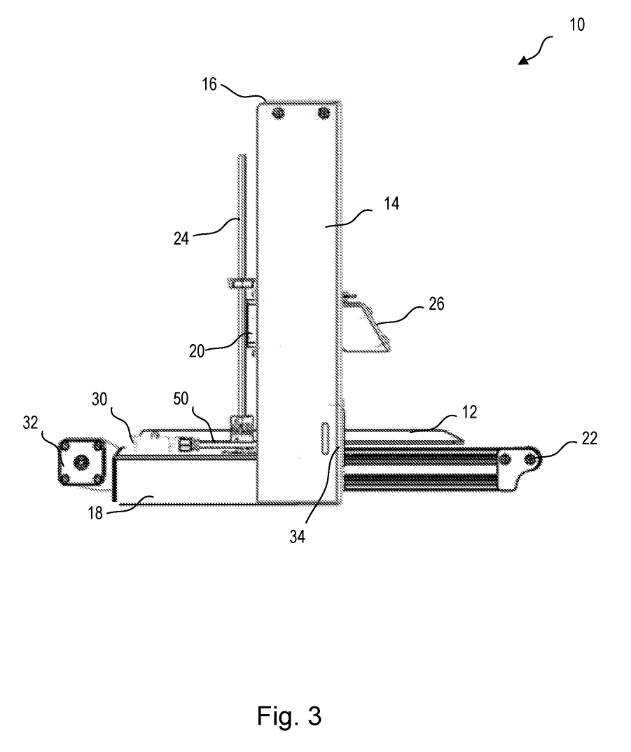

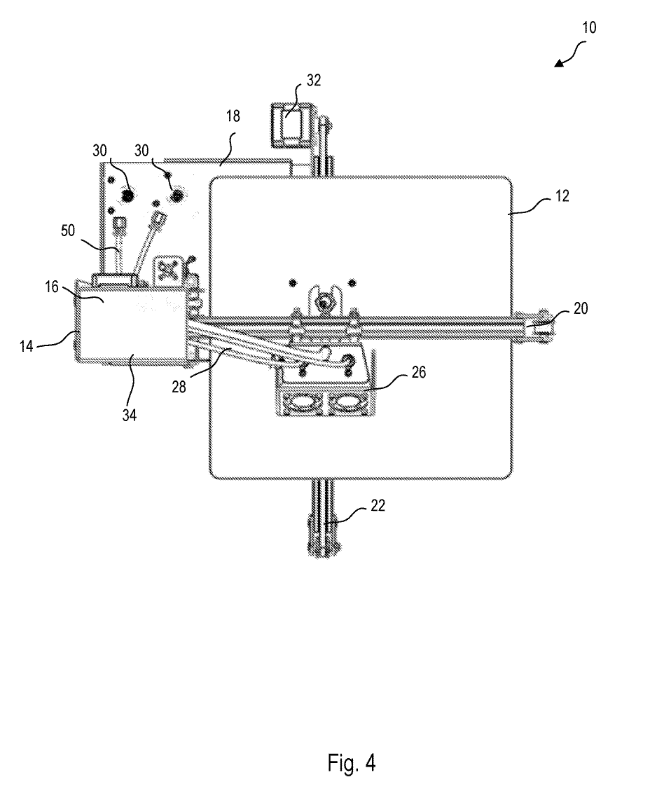

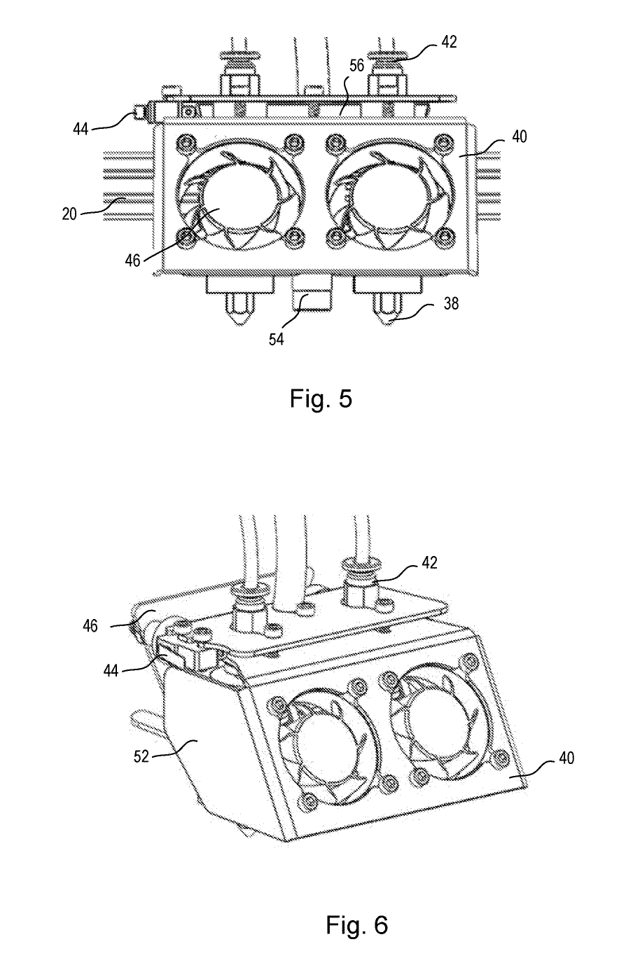

FIG. 1 is a perspective view of a 3D printer in accordance with the disclosed subject matter. FIG. 2 is a front view of the embodiment for the 3D printer of FIG. 1. FIG. 3 is a side view of the embodiment for the 3D printer of FIG. 1. FIG. 4 is a plan view of the embodiment for the 3D printer of FIG. 1. The 3D printer 10 can include a print bed 12, a L-shaped housing 14, a housing tower portion 16, a housing base portion 18, an X carriage 20, a Y carriage 22, a Z carriage extrusion rod 24, a dual extruder assembly 26, one or more filament tubes 28, one or more Gear Head Extruder Assemblies (idlers) 30, a Y carriage motor 32, and a display 34. The 3D printer 10 includes an L shaped housing 14 with cantilever X carriage 20 design.

The figures illustrate an embodiment for the 3D printing machine 10 that can include or otherwise cover the L shaped housing 14 with a tower portion 16 and a base portion 18. The L shaped housing 14 can be manufactured from a metal, plastic, resin, etc., such as an anodized Aluminum frame with “L” shape. The X carriage 20 creates a cantilever design, which can be formed by aluminum extrusion. The base 18 can include attachment points for an exemplary Gear Head Extruder Assembly 30 location easy access, a Z axis rod threaded rod attachment for the Z carriage 22 and provide a location of wiring and bowden insertion 28 to tower portion 16. The print bed 12 can be arranged off center that makes use of platform rigidity, double and single extrusion X carriage 20 with a proximity sensor 44 attached the of frontal site of the extruder assembly 26. The extruder back plate 46 can include a sheet metal design that includes or otherwise covers the extruder head 42 and fan cover 40, and proximity sensor 44.

In the embodiments, the extrusion rod of the Z carriage 22 is connected to the Aluminum “L” shape cantilever design frame housing 14 enabling the printer 10 to produce repeatable layer accuracy. The front side of the “L” shape frame design housing 14 can enclose an LCD or other type of display 34, that can include an optional side accessible SD slot. In addition, the “L” shaped exterior base housing 14 is designed to encloses electronics, all motors except for a Z axis motor, all at close wiring proximity.

In the embodiments, the extruder heads 42 can be housed within the X carriage 20 along with the x-axis end stop 44 and cooling fan 46 in a compact design, which mounted in the extrusion rod 24. Gear Head Extruder Assembly location easy access 30, Z axis rod 24 threaded rod attachment, location of wiring and bowden insertion 50 to tower portion 16, off center print bed 12 that makes use of platform rigidity. The extruder head cover 52 and fan cover 40 design makes for support of J-head styled hot ends 38 by compression against the bottom of X carriage 20 top surface and also funnels air to fins of hot ends 38 for increased cooling.

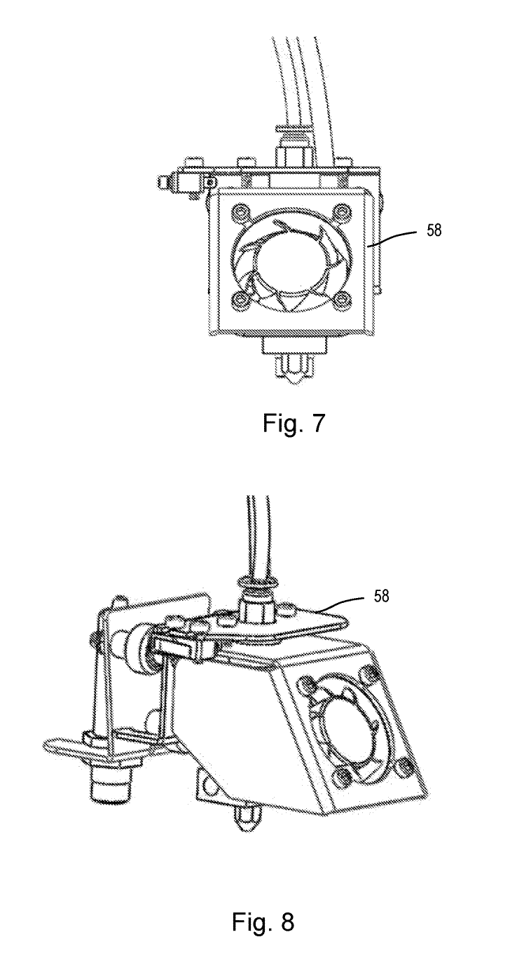

FIGS. 7 and 8 illustrate a single extrusion X carriage 58. Embodiments include the double 26 and a single extrusion X carriage 58 with proximity sensor 54 attached out of frontal site 56. The sheet metal design head cover 52 can cover the extruder head 42 and fan cover 40, and proximity sensor 54 that is mounted to the rear of the assembly 26.

Some embodiments for the 3D printer 10 include a modular design that allows for multi-size build platforms and extruders. For accurate calibration, the X carriage 20 includes or otherwise covers the proximity sensor 54 being on the back side of the X carriage 20. The proximity probe or sensor 54 is advantageous to the embodiments for 3D printing systems for providing software based auto-calibration that allows for simple and autonomous calibration.

The embodiments provide opportunities and options to minimize structural material over prior 3D printers by making use of v-slot 6063 T-5 Aluminum extrusions. By securing the X axis extrusion to the Z axis with v-slot wheels and eccentric spacers, the printer system achieves high accuracy motion for 3D printing while removing the need for a box shaped 3D printer that supports the X axis on both sides. Strategically bent aluminum sheet metal exterior can add rigidity while concealing the delicate electronic cable work of the embodiments for a 3D printer and moving parts of the motor. The linear actuation of the extruder heads (x-carriage), x axis support (Z carriage), and the print bed (y-carriage) are extended along the v-slot extrusions while advantageously reducing the visibility of moving belts within the extrusion slots. The extruder heads are housed within the X carriage 20 along with the x-axis end stop 44 and cooling fan 48 in a compact design.

The structure and features of the embodiments include a cantilever arm as the X carriage 20 that sustains high tolerances while only being supported on the Z axis. The embodiments include the pronounced “L” shape sheet metal design for housing 14 that includes the enclosed liquid crystal display (LCD) device 34 and aside accessible removable SD memory card slot the can be useful for viewing and printing files on the removable memory card. The X carriage 20 is designed to reduce the number of parts needed to assemble and to provide a pattern match the overall sheet metal exterior.

The embodiments can include or otherwise cover an L Shaped front and side housing 14 with linear motion extrusion bar 20 as X axis supported on one side, the double sided X carriage 26 configured to take advantage of the v-slot extrusion, the proximity sensor 54 on back side of 3D printer X carriage 20, the X end stop 36 on attached to carriage 20 which moves in both the X and Z axis. The 3D printer 10 of the embodiments includes the end stop 36 on the x-carriage 20 that is configured to take advantage of the sheet metal frame 52 edge that matches the bed 12, a Bowden styled Extruder 30 on back end side of 3d printer base portion 18 concealing the Bowden tube 50 in L shape tower portion 16. All Motors besides X axis are close to level with floor of the base portion 18 and in close proximity to electronics to minimize wire management. The fan cover 40 design can provide support of J-head styled hot ends 38 by compression against the bottom of X carriage 20 top surface. The fan cover 40 also funnels air to fins of hot ends 38 for increased cooling. Concealed routing of cables from underneath top of x carriage 20 hides and protects electric cables. The proximity probe 54 concealed on the back of extruder head 26, 58 is configured to take advantage of a doubled sided design of X carriage 20. The centered Proximity probe 54 with extruder head 26, 58 and Y axis bed 12 movement provides for accurate calibration.

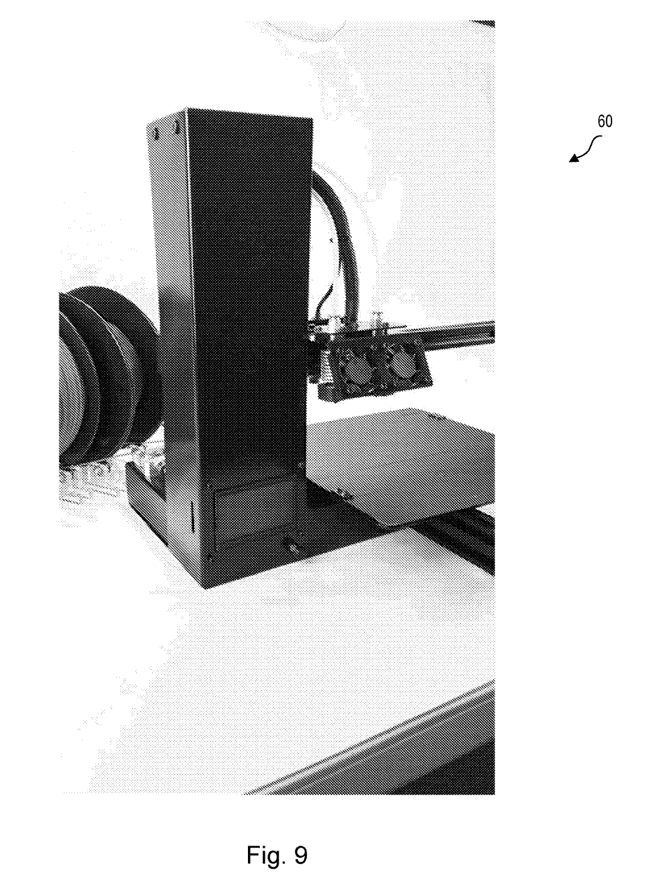

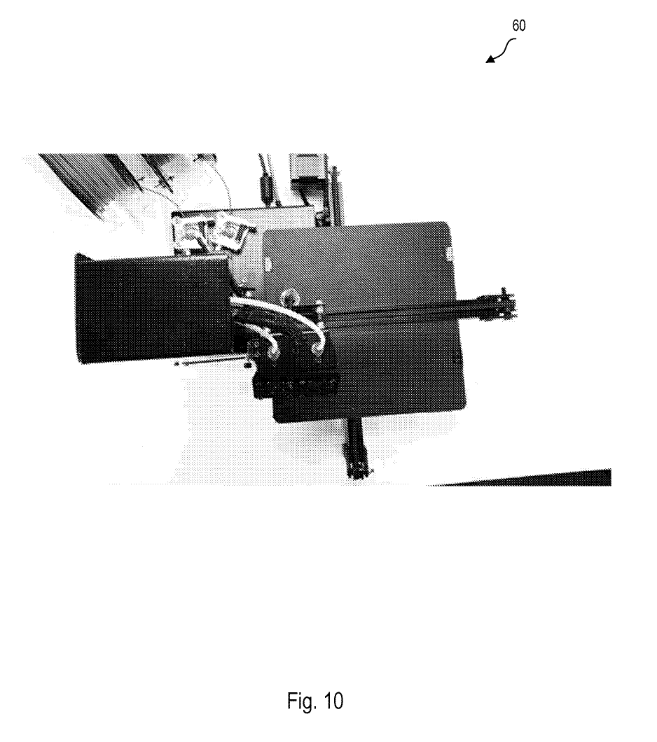

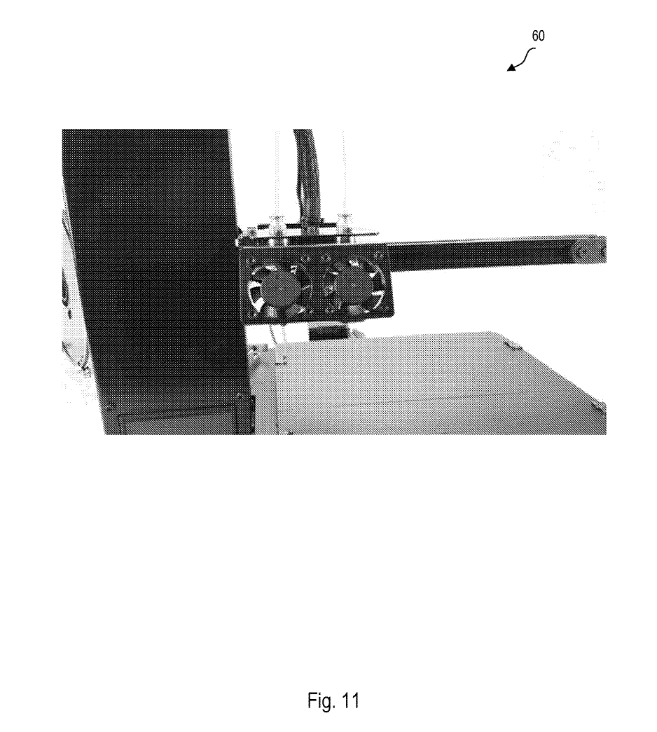

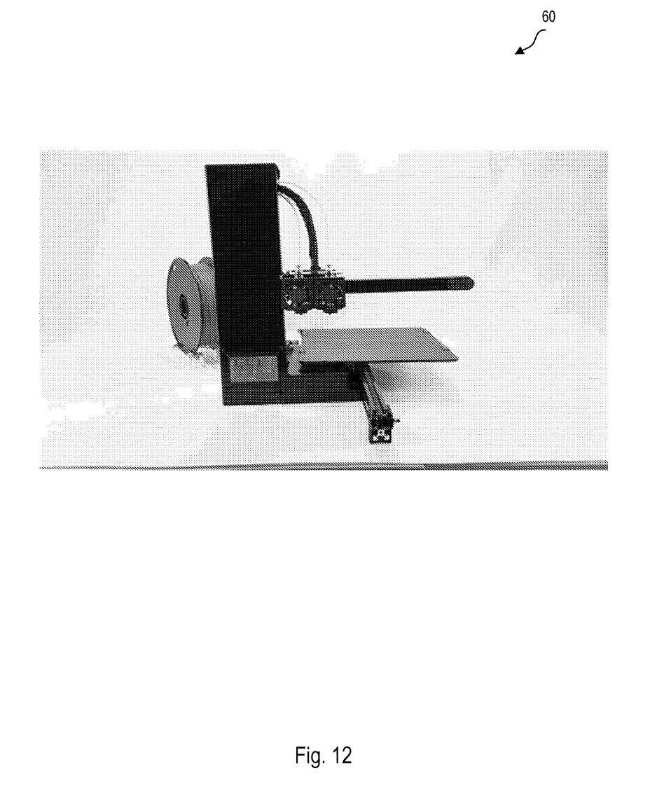

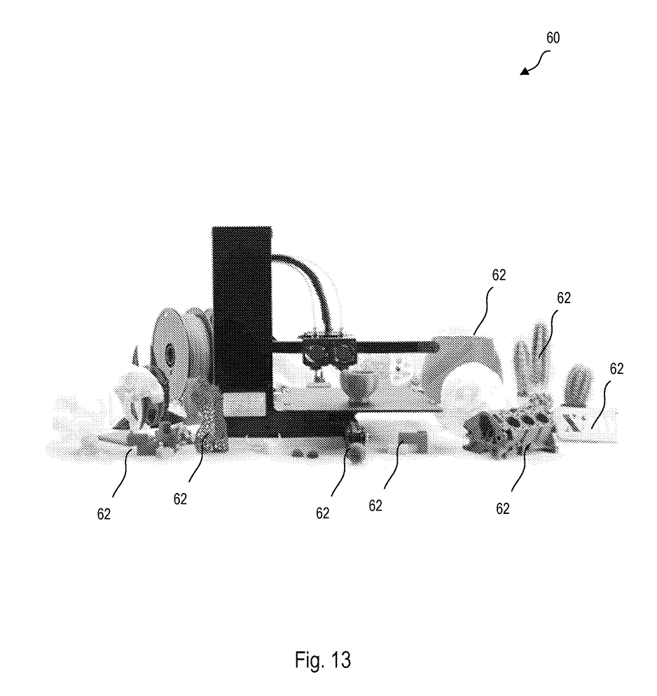

FIG. 9 is a perspective view of another embodiment for a 3D printer 60 in accordance with the disclosed subject matter. FIG. 10 is a plan view of the embodiment for a 3D printer 60 of FIG. 9. FIG. 11 is a partial front view of the embodiment for a 3D printer 60 of FIG. 9. FIG. 12 is a front perspective view of the embodiment for a 3D printer 60 of FIG. 9. The 3D printer 60 has like features and operation as the 3D printer 10. FIG. 13 is a front perspective view of the embodiment for a 3D printer of FIG. 9 with manufactured articles 62.

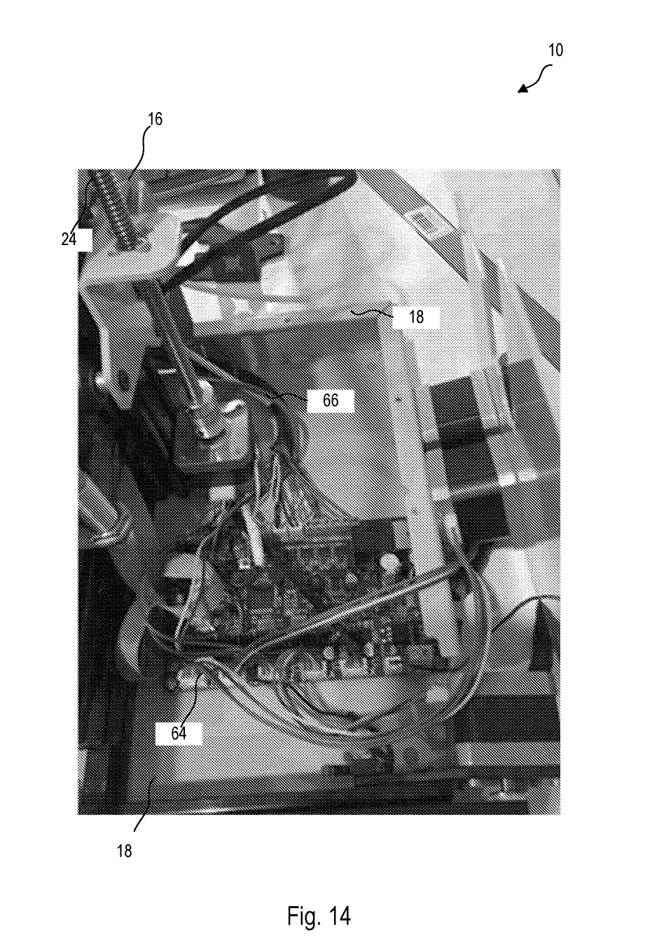

FIG. 14 is a perspective view of 3D printer internal construction and components in accordance with the disclosed subject matter. The embodiments include a sheet metal design functionality of the base portion 18, wiring 66, a PCB 64, zip tie locations on the frame of base portion 18 to secure wiring 66 within the L shape tower 14, very compact wiring system that is enclosed and secured within tower portion 16, and the motors within housing 14. The top cover of base portion 18 is removed to expose the wiring 66 inside tower portion 16. The idler motors 30 are adjacent to the printed circuit board (PCB) 64.

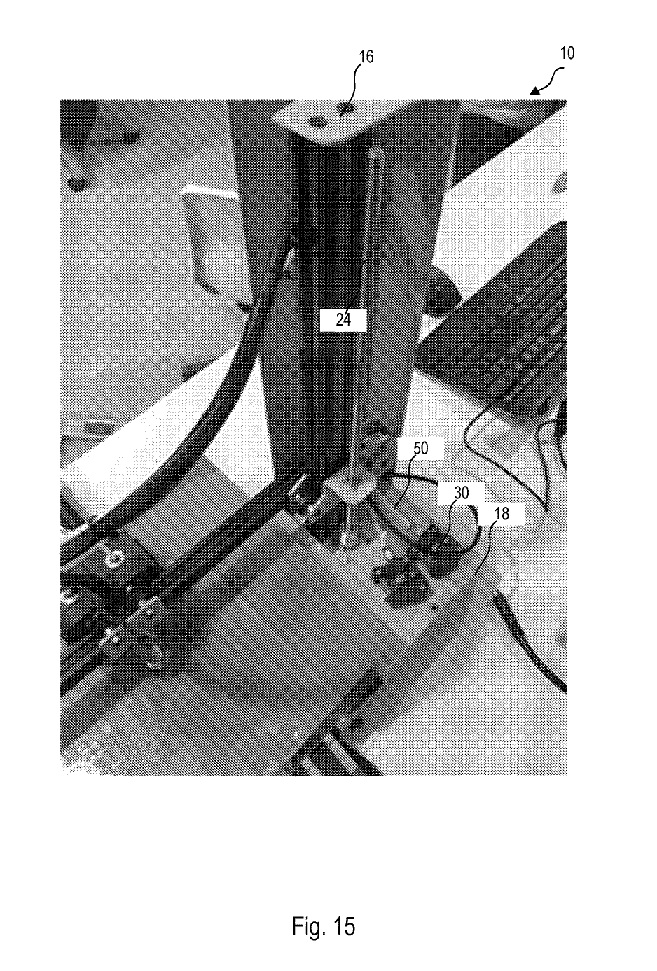

FIG. 15 is top perspective view of a Z axis housing 60 and idler motors 30 in accordance with the disclosed subject matter. An enclosure 16 that houses Z-axis from top and bottom, proving its structural integrity with just those locations. The printer 10 provides this type of support that holds the top and bottom of Z linear V extrusion. A second plate on base portion 18 holds three motors (Z axis and for two Idlers 30). The Bowden tubes 50 reach from the very bottom near the electronics, allowing for easy wiring to the board with short wires. The printer 10 includes a modular print bed 12 size by simply increasing extrusion length and three plates on main bed 12. Modular X axis that can increase in size by removing two screws from Z brackets inside the L tower 14. With the same one bracket called the hexadpater it can turn a uni-bed in to a larger bed for large sized printer.

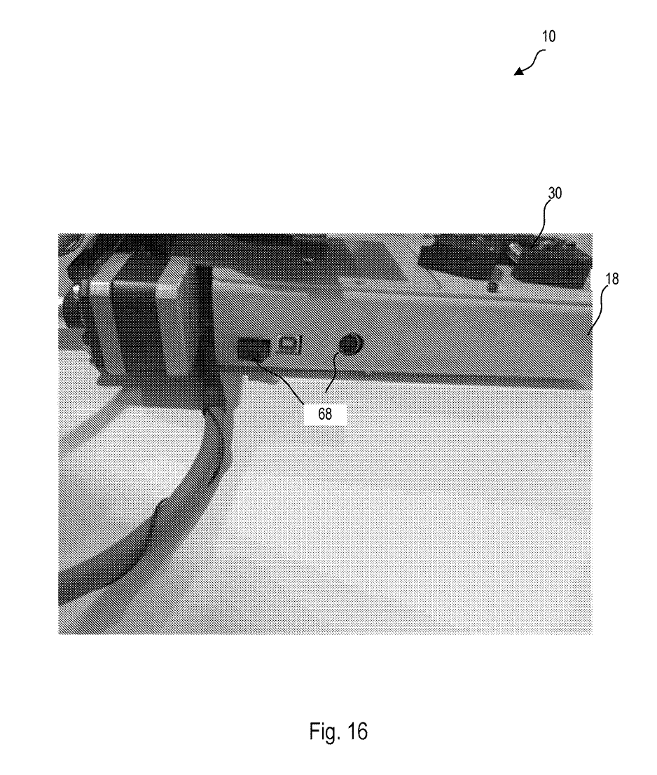

FIG. 16 is a detailed rear view of a printer base portion 18 in accordance with the disclosed subject matter. Sheet metal incorporate holes 68 for pcb power connector and switch. This provides easy size increase with minimal hardware.

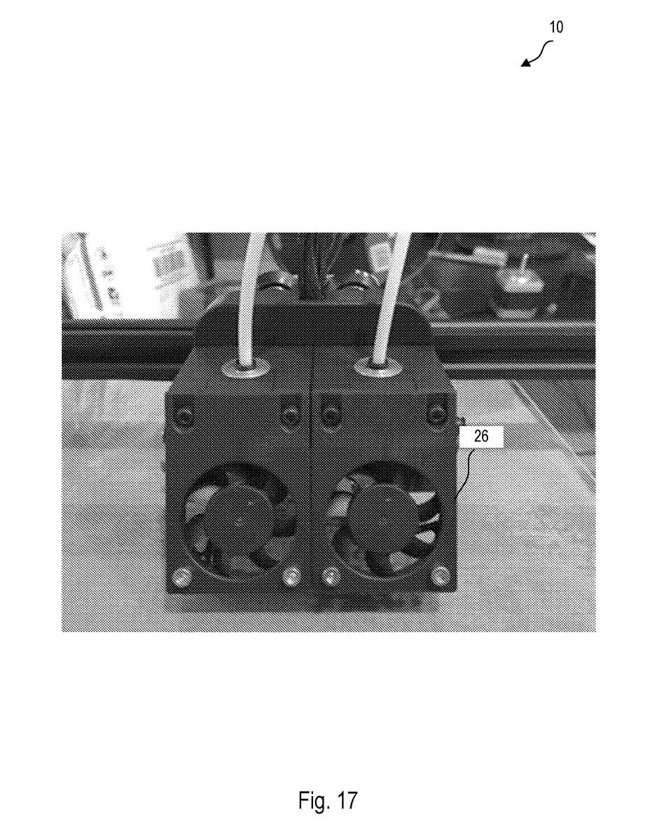

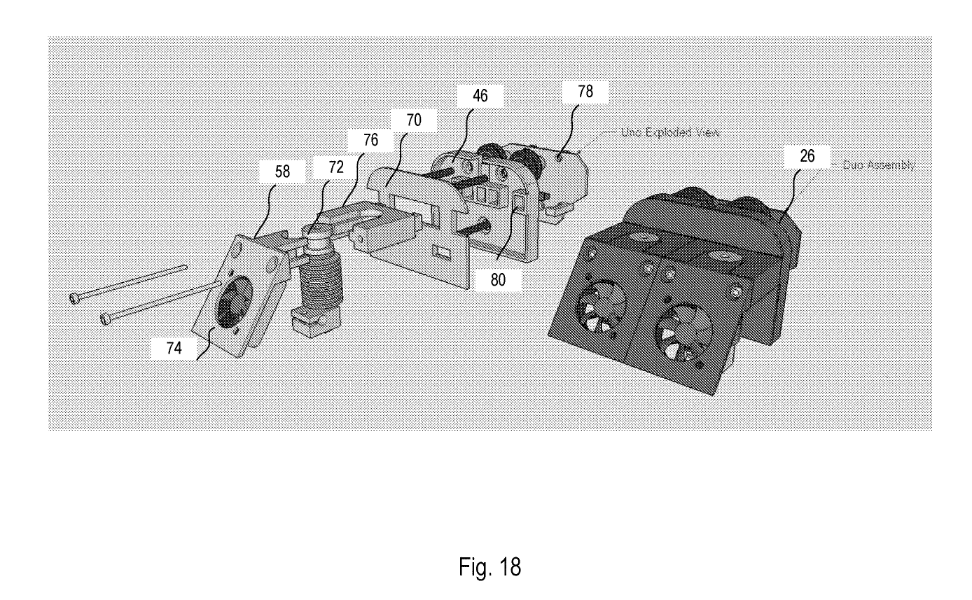

FIG. 17 is a front perspective view of an embodiment for a double extruder X carriage assembly in accordance with the disclosed subject matter. FIG. 18 is an exploded view and assembled view of an embodiment for a universal back plate 46 assembly in accordance with the disclosed subject matter. Dual 26 or mono 58 extruder capability with the same x carriage. With two screws, the user can remove the hotend and provide maintenance. The universal back plate 46 includes a receptors 80 that can receive the connector points and act as electrical conduits for either a single 58 or dual 26 extruder assembly. A cover plate 70 connects to the back plate 46 and has a through-hole that receives U-vice 76 that holds a top of a hot nozzle 72, and also receives a fan cover 74 so that all parts fit firmly together. A rear plate 78 connects to the back plate 46, the X carriage 20 attaching between the rear plate 78 and the back plate 46.

Another advantage is to provide a cantilever consumer 3D printer with dual extruders 26. To accomplish this, the idler motors 30 are located by the x-axis thus making the x carriage 20 light and more mobile. The two idler motors 30 are located on the floor of base portion 18 off of the Z-axis, removing downward force on the z motor that may cause it to fail. A same bracket that holds the filament fan also pinches the hotends, which provides functional multicapabilities. The X carriage 20 has built-in nut inserts for the hot ends to be secured.

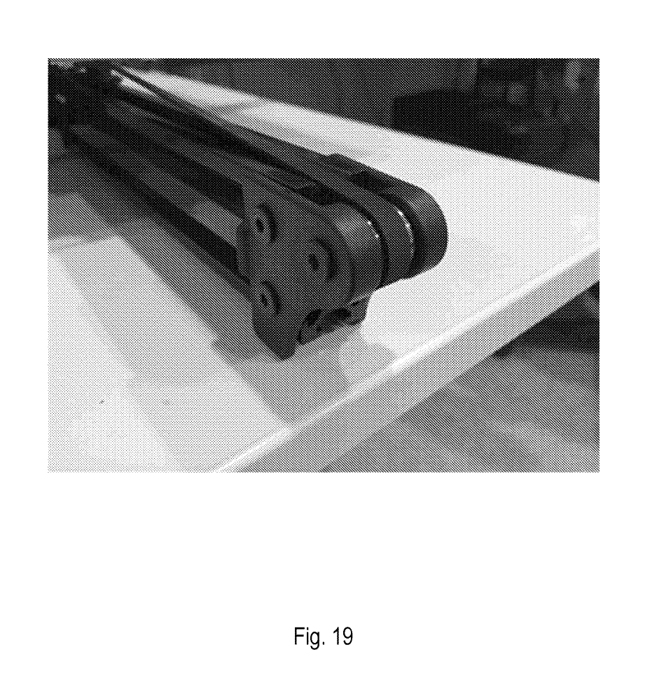

FIG. 19 is a detailed perspective view of pulley systems in accordance with the disclosed subject matter. Extrusions are tapped in specific locations to remove the need for “T-nuts” which removes assembly time and provides faster modular modifications. For example, the x-axis and y-axis can be modified in length without the need for extra Hardware changes. Injection molded Y pulleys provide built in washer and spacing for precisely two bearings (625z bearings). This is completely custom and unique because it does not require outer shell on the bearings. This minimizes hardware. Meaning easier maintenance of pulley systems. Y motor brackets hold the motor and end stop together in one piece. Removable glass bed with holding clips that also can support heated bed.

I claim:

1. A 3D printing system, comprising:
an L Shape front and side view housing;
a linear motion extrusion bar; and
a universal extrusion assembly back plate that can mount a single or double X axis extruder.

2. The 3D printing system of claim 1, further comprising:
a double sided X carriage configured to take advantage of a v-slot extrusion.

3. The 3D printing system of claim 1, further comprising:
a Proximity sensor on back side of 3D printer X carriage.

4. The 3D printing system of claim 1, further comprising:
an X endstop attached to a carriage which moves in both the X and Z axis.

5. The 3D printing system of claim 1, further comprising:
an endstop on the x-carriage that is configured to take advantage of the sheet metal frame edge that matches the bed.

6. The 3D printing system of claim 1, further comprising:
a Bowden styled extruder on back end side of a 3d printer concealing a Bowden tube in an L shape tower.

7. The 3D printing system of claim 1, further comprising:
one or more motors besides X axis close to level with floor and in close proximity to electronics to minimize wire management.

8. The 3D printing system of claim 1, further comprising:
a fan cover design that can provide support of J-head styled hot ends by compression against the bottom of X carriage top surface.

9. The 3D printing system of claim 1, further comprising:
a fan cover also funnels air to fins of hot ends for increased cooling.

10. The 3D printing system of claim 1, further comprising:
the housing providing concealed routing of cables from underneath top of x carriage.

11. The 3D printing system of claim 1, further comprising:
a proximity probe concealed on the back of extruder head that is configured to take advantage of a doubled sided design of X carriage.

12. The 3D printing system of claim 1, further comprising:
a centered proximity probe with extruder head and Y axis bed movement for accurate calibration.
